(19) United States
(12) Patent Application Publication
(10) Pub. No.: US 2025/0197553 A1
(43) Pub. Date: Jun. 19, 2025

(54) POLYURETHANE ACRYLATE RESIN AND RESIN COMPOSITION

(71) Applicant: INDUSTRIAL TECHNOLOGY RESEARCH INSTITUTE, Hsinchu (TW)

(72) Inventors: Yi-Chun CHEN, Hsinchu City (TW); Yeu-Ding CHEN, Zhunan Township (TW); Chih-Hao LIN, Taoyuan City (TW); Kai-Chi CHEN, Zhubei City (TW)

(73) Assignee: INDUSTRIAL TECHNOLOGY RESEARCH INSTITUTE, Hsinchu (TW)

(21) Appl. No.: 18/399,082

(22) Filed: Dec. 28, 2023

(30) Foreign Application Priority Data
Dec. 14, 2023 (TW) 112148656

(51) Int. Cl. C08G 18/32

(52) U.S. Cl. CPC C08G 18/329

(57) ABSTRACT

A polyurethane acrylate resin is formed by reacting 6 to 30 parts by equivalent of (A) imine diol; 6 to 30 parts by equivalent of (B) polyester diol, polycarbonate diol, or a combination thereof; 10 to 30 parts by equivalent of (C) hydroxyalkyl acrylate, hydroxyalkyl methacrylate, or a combination thereof; and 50 parts by equivalent of (D) diisocyanate, in which (A) imine diol has a chemical structure of

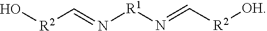

### CROSS REFERENCE TO RELATED APPLICATIONS

The present application is based on, and claims priority from, Taiwan Application Serial Number 112148656, filed on Dec. 14, 2023, the disclosure of which is hereby incorporated by reference herein in its entirety.

### TECHNICAL FIELD

The technical field relates to a resin composition, and in particular it relates to a polyurethane acrylate resin utilized in a resin composition.

### BACKGROUND

Polyurethane resins are block copolymers with a molecular chain composed of rigid segments and soft segments. Polyurethane resins have excellent wear resistance, good elongation, high tensile strength, and the like. They find wide application in several fields such as electronics, textiles, medical devices, construction, and building materials. Although a polyurethane resin can be degraded by hydrolysis (200° C., 16 bar) and alcoholysis (180° C. to 220° C.), the degradation conditions are too harsh (>180° C.) and the degradation rate is too slow (>12 hours). As such, the recycling efficiency of polyurethane resins and their applications (e.g. electronic adhesive element or coating substrate) is poor.

Accordingly, what is called for is a novel polyurethane resin and a resin composition, including a polyurethane resin that quickly degrade under mild conditions, to facilitate reworking and recycling.

### SUMMARY

One embodiment of the disclosure provides a polyurethane acrylate resin, being formed by reacting 6 to 30 parts by equivalent of (A) imine diol; 6 to 30 parts by equivalent of (B) polyester diol, polycarbonate diol, or a combination thereof; 10 to 30 parts by equivalent of (C) hydroxyalkyl acrylate, hydroxyalkyl methacrylate, or a combination thereof; and 50 parts by equivalent of (D) diisocyanate, wherein (A) imine diol has a chemical structure of

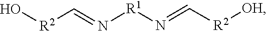

wherein R¹ is

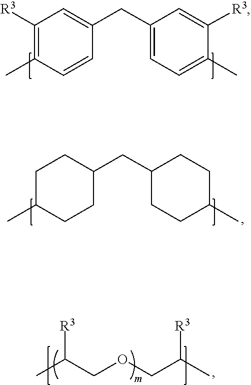

linear —(CₙH₂ₙ)— or branched —(CₙH₂ₙ)—, wherein m=2 to 40, n=2 to 16, and each of R³ is independently C₁₋₆ alkyl group; and each of R² is independently substituted or unsubstituted C₂₋₂₄ alkylene group or C₃₋₂₄ cycloalkylene group, or substituted or unsubstituted C₆₋₂₄ monocyclic or bicyclic arylene group.

One embodiment of the disclosure provides a resin composition, including 100 parts by weight of the described polyurethane acrylate resin; 50 to 200 parts by weight of a multi-acrylate compound; and 5 to 35 parts by weight of a radical initiator.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a polyurethane acrylate resin formed by reacting 6 to 30 parts by equivalent of (A) imine diol; 6 to 30 parts by equivalent of (B) polyester diol, polycarbonate diol, or a combination thereof; 10 to 30 parts by equivalent of (C) hydroxyalkyl acrylate, hydroxyalkyl methacrylate, or a combination thereof; and 50 parts by equivalent of (D) diisocyanate. If the amount of (A) imine diol is too low (i.e. the amount of (B) polyester diol, polycarbonate diol, or a combination thereof is too high), the cured resin composition of the polyurethane acrylate and the multi-acrylate compound is difficult to be degraded. If the amount of (A) imine diol is too high (i.e. the amount of (B) polyester diol, polycarbonate diol, or a combination thereof is too low), the polyurethane acrylate resin and the multi-acrylate compound cannot be uniformly mixed due to their compatibility is lowered. If the amount of (C) hydroxyalkyl acrylate, hydroxyalkyl methacrylate, or a combination thereof is too low, the molecular weight of the polyurethane acrylate resin will be too high, and the polyurethane acrylate resin cannot easily mix with the multi-acrylate compound due to its overly high viscosity. If the amount of (C) hydroxyalkyl acrylate, hydroxyalkyl methacrylate, or a combination thereof is too high, the molecular weight of the polyurethane acrylate resin will be too low to appear the excellent properties such as wear resistance, elongation, high tensile strength, and the like of the polyurethane resin.

For example, (A) imine diol has a chemical structure of

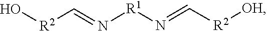

wherein R¹ is

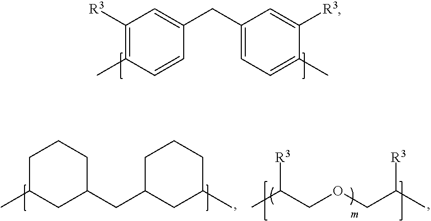

linear —(CₙH₂ₙ)— or branched —(CₙH₂ₙ)—, wherein m=2 to 40, n=2 to 16, and each of R³ is independently C₁₋₆ alkyl group; and each of R² is independently substituted or unsubstituted C₂₋₂₄ alkylene group or C₃₋₂₄ cycloalkylene group, or substituted or unsubstituted C₆₋₂₄ monocyclic or bicyclic arylene group.

In some embodiments, each of R² is independently

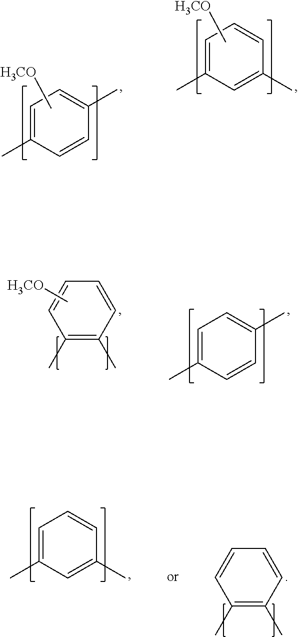

In some embodiments, the polyester diol includes polycaprolactone diol, poly(ethylene glycol adipate) diol, poly(ethylene terephthalate) diol, polypentadecanolactone diol, polylaurolactone diol, or a combination thereof, and the polycarbonate diol includes poly(hexamethylene carbonate) diol, poly(pentamethylene carbonate) diol, poly(tetramethylene carbonate) diol, poly(trimethylene carbonate) diol, poly(dimethylene carbonate) diol, or a combination thereof. Note that the above polyester diol or the polycarbonate diol cannot be arbitrarily replaced with any other common polymer diol such as poly(ethylene glycol) or poly(tetramethylene glycol). If the other polymer diol is adopted, the polyurethane acrylate resin and the multi-acrylate compound cannot be uniformly mixed due to their compatibility is lowered.

In some embodiments, the hydroxyalkyl acrylate includes 2-hydroxyethyl acrylate, 2-hydroxypropyl acrylate, 4-hydroxybutyl acrylate, methyl 2-(1-hydroxyethyl)acrylate, or a combination thereof, and the hydroxyalkyl methacrylate includes 2-hydroxyethyl methacrylate, 2-hydroxypropyl methacrylate, 4-hydroxybutyl methacrylate, methyl 2-(1-hydroxyethyl)methacrylate, or a combination thereof.

In some embodiments, the diisocyanate includes isophorone diisocyanate, m-xylylene diisocyanate, toluene-2,4-diisocyanate, diphenylmethane diisocyanate, dicyclohexylmethane diisocyanate, lysine diisocyanate, or a combination thereof.

In some embodiments, the total parts by equivalent of (A) imine diol, (B) polyester diol, polycarbonate diol, or a combination thereof, and (C) hydroxyalkyl acrylate, hydroxyalkyl methacrylate, or a combination thereof is equal to the parts by equivalent of (D) diisocyanate. If the parts by equivalent of (D) diisocyanate are too low, the molecular weight of the polyurethane acrylate resin will be too high, and the polyurethane acrylate resin cannot easily mix with the multi-acrylate compound due to its overly high viscosity. If the parts by equivalent of (D) diisocyanate are too high, the molecular weight of the polyurethane acrylate resin will be too low to appear the excellent properties of wear resistance, elongation, tensile strength, and the like of the polyurethane resin.

In some embodiments, the polyurethane acrylate resin has a weight average molecular weight (Mw) of 500 to 20000. If the Mw of the polyurethane acrylate resin is too low, the excellent properties such as wear resistance, elongation, high tensile strength, and the like of the polyurethane resin cannot appear. If the Mw of the polyurethane acrylate resin is too high, the viscosity of the polyurethane acrylate resin will be too high to mix well with the multi-acrylate compound.

One embodiment of the disclosure provides a resin composition, including 100 parts by weight of the described polyurethane acrylate resin; 50 to 200 parts by weight of a multi-acrylate compound; and 5 to 35 parts by weight of a radical initiator. If the multi-acrylate compound amount is too low, the resin composition of the polyurethane acrylate resin and the multi-acrylate compound is difficult to be degraded after cured. If the multi-acrylate compound amount is too high, the compatibility of the polyurethane acrylate resin and the multi-acrylate compound will be reduced and cannot be uniformly mixed.

In some embodiments, the multi-acrylate compound includes tris[2-(acryloyloxy)ethyl] isocyanurate, bisphenol A glycerolate dimethacrylate, tricyclodecane dimethanol diacrylate, bis(2-acryloyloxyethyl) isocyanurate, terephthalic acid diallyl ester, bisphenol A ethoxylate diacrylate, polycaprolactone diacrylate, 1,3-butanediol diacrylate, 1,4-butanediol diacrylate, 1,6-hexanediol diacrylate, ethylene glycol diacrylate, di(ethylene glycol) diacrylate, poly(ethylene glycol) diacrylate, poly(propylene glycol) diacrylate, neopentyl glycol diacrylate, tetra(ethylene glycol) diacrylate, trimethylaniline diacrylate, tri(ethylene glycol) diacrylate, 9-(acryloyloxy)nonyl acrylate, ethoxylated trimethylolpropane diacrylate, tri(propylene glycol) diacrylate, or a combination thereof. In some embodiments, the radical initiator includes photo initiator, thermal initiator, or a combination thereof.

The cured resin composition can be quickly degraded under relatively mild conditions (weak acid/weak alkaline, 55° C.), such as the best degradation of 70% in 0.5 hours. Therefore, the resin composition can be used for adhering electronic components, and the cured resin composition can be easily degraded during reworking or recycling to decrease the time and cost of disassembly.

Below, exemplary embodiments are described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Synthesis Example 1 (Imine Diol (Ia))

10.16 g of 4,4′-methylene bis(2-ethylaniline) (MBEA, 0.04 mole), 6.09 g of 4-hydroxy-3-methoxybenzaldehyde (VAN, 0.04 mole), 4.89 g of 3-hydroxy benzaldehyde (HBA, 0.04 mole), and 0.09 g of p-toluenesulfonic acid were weighed, 50 mL of anhydrous alcohol was added thereto, and then heated to 80° C. to react under nitrogen for 5 hours. The reaction result was cooled to room temperature, and the crude was extracted by ethyl acetate and washed with de-ionized water 3 times to collect the organic layer. The organic layer was dried by anhydrous magnesium sulfate, and then filtered to obtain the filtrate. The filtrate was concentrated to obtain 15.8 g of yellow brown solid product as imine diol (Ia). The hydrogen spectrum of the product is shown below: ¹H NMR (Acetone-d₆; 400 MHz): δ: 8.40 (s, 1H, —CH═N—), 8.33 (s, 1H, —CH═N—), 7.71 (s, 1H, Ar—H), 7.50 (s, 1H, Ar—H), 7.47 (m, 1H, Ar—H), 7.38 (m, 1H, Ar—H), 7.20 (m, 1H, Ar—H), 7.15 (m, 1H, Ar—H), 6.82-7.03 (m, 7H, Ar—H), 3.92 (s, 2H, Ph-CH₂-Ph), 3.89 (s, 3H, —OCH₃), 1.29 (q, 4H, —CH₂CH₃), 1.19 (t, 6H, —CH₂CH₃). The imine diol (Ia) had a chemical structure of

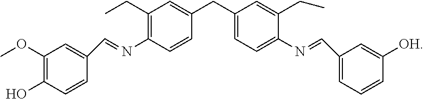 [SMILES: CCc1cc(Cc2ccc(/N=C/c3ccc(O)c(OC)c3)c(CC)c2)ccc1/N=C/c1cccc(O)c1]

### Synthesis Example 2 (Imine Diol (Ib))

10.16 g of MBEA (0.04 mole), 12.18 g of VAN (0.08 mole), and 0.09 g of p-toluenesulfonic acid were weighed, 50 mL of anhydrous alcohol was added thereto, and then heated to 80° C. to react under nitrogen for 5 hours. The reaction result was cooled to room temperature, and the crude was extracted by ethyl acetate and washed with de-ionized water 3 times to collect the organic layer. The organic layer was dried by anhydrous magnesium sulfate, and then filtered to obtain the filtrate. The filtrate was concentrated to obtain 16.3 g of yellow brown solid product as imine diol (Ib). The hydrogen spectrum of the product is shown below: ¹H NMR (Acetone-d₆; 400 MHz) δ: 8.40 (s, 2H, —CH═N—), 7.69 (s, 2H, Ar—H), 7.45 (d, 2H, Ar—H), 7.16 (d, 2H, Ar—H), 6.85-7.05 (m, 6H, Ar—H), 3.89 (s, 2H, Ph-CH₂-Ph), 3.79 (s, 6H, —OCH₃), 1.27 (q, 4H, —CH₂CH₃), 1.15 (t, 6H, —CH₂CH₃). The imine diol (Ib) had a chemical structure of

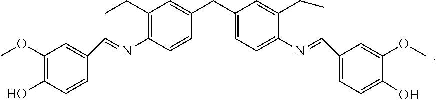

### Synthesis Example 3 (Imine Diol (II))

4.65 g of hexamethylene diamine (HMDA, 0.04 mole), 6.09 g of VAN (0.04 mole), 4.89 g of HBA (0.04 mole), and 0.09 g of p-toluenesulfonic acid were weighed, 50 mL of anhydrous alcohol was added thereto, and then heated to 80° C. to react under nitrogen for 5 hours. The reaction result was cooled to room temperature, and the crude was concentrated and cooled (4° C.) to precipitate the product and then filtered. The filtered cake was washed with ice ethanol, and then dried to obtain 14.3 g of orange yellow solid product as imine diol (II). The hydrogen spectrum of the product is shown below: ¹H NMR (d-DMSO; 400 MHz) δ:8.17 (s, 1H, —CH═N—), 8.07 (s, 1H, —CH═N—), 7.27 (s, 1H, Ar—H), 7.23 (m, 3H, Ar—H), 7.13 (s, 1H, Ar—H), 7.07 (m, 2H, Ar—H), 6.83 (d, 1H, Ar—H), 6.80 (d, 1H, Ar—H), 3.75 (s, 3H, —OCH₃), 3.46 (t, 2H, ═NCH₂—), 3.41 (t, 2H, ═NCH₂—), 1.54 (s, 4H═NCH₂—CH₂—), 1.31 (s, 4H, —CH₂—). The imine diol (II) had a chemical structure of

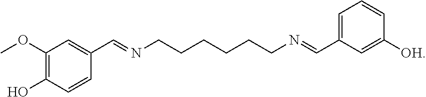 [SMILES: COc1cc(/C=N/CCCCCC/N=C/c2cccc(O)c2)ccc1O]

### Synthesis Example 4 (Imine Diol (III))

6.81 g of isophorone diamine (IPDI, 0.04 mole), 6.09 g of VAN (0.04 mole), 6.09 g of 2-hydroxy-3-methoxybenzaldehyde (o-Van, 0.04 mole), and 0.09 g of p-toluenesulfonic acid were weighed, 50 mL of anhydrous alcohol was added thereto, and then heated to 80° C. to react under nitrogen for 5 hours. The reaction result was cooled to room temperature, and the crude was extracted by ethyl acetate and washed with de-ionized water 3 times to collect the organic layer. The organic layer was dried by anhydrous magnesium sulfate, and then filtered to obtain the filtrate. The filtrate was concentrated to obtain 16.7 g of yellow brown solid product as imine diol (III). The hydrogen spectrum of the product is shown below: ¹H NMR (Acetone-d₆; 400 MHz) δ: 8.72 (s, 1H, —CH═N—), 8.21 (s, 1H, —CH═N—), 7.49 (s, 1H, Ar—H) 7.19 (dd, 1H, Ar—H), 6.98 (m, 2H, Ar—H), 6.85 (m, 2H, Ar—H), 3.92 (s, 3H, —OCH₃), 3.98 (s, 3H, —OCH₃), 2.85 (m, 2H, CH₂—N, —CH—N), 1.75-1.30 (m, 6H, Cy-CH₂), 1.25 (m, 3H, —CH₃), 1.21 (m, 3H, —CH₃), 0.98 (m, 3H, —CH₃). The imine diol (III) had a chemical structure of:

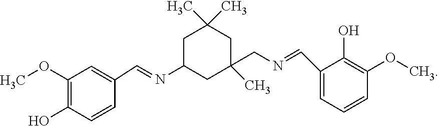 [SMILES: COc1cc(/C=N/C2CC(C)(C)CC(C)(C/N=C/c3cccc(OC)c3O)C2)ccc1O]

### Resin 1

32.0 g of the imine diol (Ia), 35.0 g of poly(hexamethylene carbonate) diol (PHC-diol, commercially available from Asahi Kasei Co., Japan), 26.0 g of 2-hydroxyethyl methacrylate (HEMA), 0.138 g of dibutyl tin dilaurate (DBTDL), 0.014 g of hydroquinone monomethyl ether (MEHQ), and 70 mL of anhydrous THF were completely mixed and then heated to 55° C. 44.5 g of isophorone diisocyanate (IPDI) was slowly added to the mixture. After feeding IPDI, the mixture reacted at 55° C. for 15 hours to obtain Resin 1, which was tracked by FT-IR to confirm whether the reaction was completed (confirm whether the —NCO absorption peak has disappeared). Resin 1 was analyzed by gel permeation chromatography (GPC) to measure its molecular weight (Mw; 3,422) and polydispersity index (PDI, 1.75). GPC was performed with a solvent of THF, in which polystyrenes of ten different molecular weights (e.g. 580 to 316000) were used to make a calibration line. The sample such as Resin 1 was analyzed to calculate its molecular weight using the calibration line and interpolation method. The GPC was performed at room temperature (25° C.), and the flow rate of THF was 1.0 mL/min.

### Resin 2

32.0 g of the imine diol (Ia), 35.0 g of PHC-diol, 11.6 g of 2-hydroxyethyl acrylate (HEA), 0.112 g of DBTDL, 0.011 g of MEHQ, and 55 mL of anhydrous THF were completely mixed and then heated to 55° C. 33.3 g of IPDI was slowly added to the mixture. After feeding IPDI, the mixture reacted at 55° C. for 15 hours to obtain Resin 2, which was tracked by FT-IR to confirm whether the reaction was completed (confirm whether the —NCO absorption peak has disappeared). Resin 2 was analyzed by GPC (with polystyrene as standard) to measure its Mw (3,862) and PDI (1.86).

### Resin 3

24.6 g of the imine diol (Ia), 50.0 g of PHC-diol, 13.0 g of HEMA, 0.121 g of DBTDL, 0.012 g of MEHQ, and 60 mL of anhydrous THF were completely mixed and then heated to 55° C. 33.3 g of IPDI was slowly added to the mixture. After feeding IPDI, the mixture reacted at 55° C. for 15 hours to obtain Resin 3, which was tracked by FT-IR to confirm whether the reaction was completed (confirm whether the —NCO absorption peak has disappeared). Resin 3 was analyzed by GPC (with polystyrene as standard) to measure its Mw (7,189) and PDI (2.21).

### Resin 4

51.7 g of the imine diol (Ia), 90.0 g of polycaprolactone diol (PCL-diol, commercially available from Sigma-Aldrich), 13.0 g of HEMA, 0.198 g of DBTDL, 0.020 g of MEHQ, and 100 mL of anhydrous THF were completely mixed and then heated to 55° C. 44.5 g of IPDI was slowly added to the mixture. After feeding IPDI, the mixture reacted at 55° C. for 15 hours to obtain Resin 4, which was tracked by FT-IR to confirm whether the reaction was completed (confirm whether the —NCO absorption peak has disappeared). Resin 4 was analyzed by GPC (with polystyrene as standard) to measure its Mw (7,235) and PDI (2.32).

### Resin 5

13.7 g of the imine diol (Ib), 97.5 g of PCL-diol, 5.8 g of HEA, 0.139 g of DBTDL, 0.014 g of MEHQ, and 70 mL of anhydrous THF were completely mixed and then heated to 55° C. 22.3 g of IPDI was slowly added to the mixture. After feeding IPDI, the mixture reacted at 55° C. for 15 hours to obtain Resin 5, which was tracked by FT-IR to confirm whether the reaction was completed (confirm whether the —NCO absorption peak has disappeared). Resin 5 was analyzed by GPC (with polystyrene as standard) to measure its Mw (10,679) and PDI (2.35).

### Resin 6

6.37 g of the imine diol (II), 114.0 g of PCL-diol, 6.5 g of HEMA, 0.146 g of DBTDL, 0.015 g of MEHQ, and 75 mL of anhydrous THF were completely mixed and then heated to 55° C. 18.8 g of m-xylene Diisocyanate (XDI) was slowly added to the mixture. After feeding XDI, the mixture reacted at 55° C. for 15 hours to obtain Resin 6, which was tracked by FT-IR to confirm whether the reaction was completed (confirm whether the —NCO absorption peak has disappeared). Resin 6 was analyzed by GPC (with polystyrene as standard) to measure its Mw (11,350) and PDI (2.45).

### Comparative Resin 1

2.61 g of the imine diol (Ib), 45.0 g of PHC-diol, 11.6 g of HEA, 0.082 g of DBTDL, 0.008 g of MEHQ, and 40 mL of anhydrous THF were completely mixed and then heated to 55° C. 18.8 g of XDI was slowly added to the mixture. After feeding XDI, the mixture reacted at 55° C. for 15 hours to obtain Comparative Resin 1, which was tracked by FT-IR to confirm whether the reaction was completed (confirm whether the —NCO absorption peak has disappeared). Comparative Resin 1 was analyzed by GPC (with polystyrene as standard) to measure its Mw (5,830) and PDI (1.95).

### Comparative Resin 2

47.79 g of the imine diol (II), 30.0 g of PCL-diol, 11.6 g of HEA, 0.134 g of DBTDL, 0.013 g of MEHQ, and 70 mL of anhydrous THF were completely mixed and then heated to 55° C. 44.5 g of IPDI was slowly added to the mixture. After feeding IPDI, the mixture reacted at 55° C. for 15 hours to obtain Comparative Resin 2, which was tracked by FT-IR to confirm whether the reaction was completed (confirm whether the —NCO absorption peak has disappeared). Comparative Resin 2 was analyzed by GPC (with polystyrene as standard) to measure its Mw (4,032) and PDI (2.05).

### Comparative Resin 3

26.6 g of the imine diol (II), 50.0 g of polytetramethylene ether glycol (PTMEG, commercially available from Sigma-Aldrich), 11.6 g of HEA, 0.110 g of DBTDL, 0.011 g of MEHQ, and 55 mL of anhydrous THF were completely mixed and then heated to 55° C. 33.3 g of IPDI was slowly added to the mixture. After feeding IPDI, the mixture reacted at 55° C. for 15 hours to obtain Comparative Resin 3, which was tracked by FT-IR to confirm whether the reaction was completed (confirm whether the —NCO absorption peak has disappeared). Comparative Resin 3 was analyzed by GPC (with polystyrene as standard) to measure its Mw (6,953) and PDJ (2.16).

### Comparative Resin 4

21.9 g of the imine diol (III), 100.0 g of PCL-diol, 11.6 g of HEA, 0.167 g of DBTDL, 0.0167 g of MEHQ, and 85 mL of anhydrous THF were completely mixed and then heated to 55° C. 33.3 g of IPDI was slowly added to the mixture. After feeding IPDI, the mixture reacted at 55° C. for 15 hours to obtain Comparative Resin 4, which was analyzed by ¹H NMR, in which imine signal (8.72 ppm to 8.21 ppm) disappeared and new aldehyde signal (9.9 ppm) appeared. It means that the imine reverse reacted to form aldehyde, and polymer could not be formed.

TABLE 1
Synthesis of polyurethane acrylate resin

| Resin | | | | |
|---|---|---|---|---|
| Resin 1 | Resin 2 | Resin 3 | Resin 4 | Resin 5 |

g (equivalent)

| (A)diol | Imine diol (Ia) | 32.0 | (0.13) | 32.0 | (0.13) | 24.6 | (0.10) | 51.7 | (0.21) | — | |
|---|---|---|---|---|---|---|---|---|---|---|---|
| | Imine diol (Ib) | — | | — | | — | | — | | 13.7 | (0.053) |
| | Imine diol (II) | — | | — | | — | | — | | — | |
| | Imine diol (III) | — | | — | | — | | — | | — | |
| (B) | Polyester diol | — | | — | | — | | 90.0 | (0.09) | 97.5 | (0.098) |
| Polymer diol | PCL-diol | | | | | | | | | | |
| | (Mn 2000) (III) | | | | | | | | | | |
| | Polycarbonate | 35.0 | (0.07) | 35.0 | (0.07) | 50.0 | (0.10) | — | | — | |
| | diol PHC-diol | | | | | | | | | | |
| | (Mn 1000) (IV) | | | | | | | | | | |
| | Polyether diol | | | | | | | | | | |
| | PTMEG | | | | | | | | | | |
| | (Mn 2000) | | | | | | | | | | |
| Hydroxyalkyl | HEMA | 26.0 | (0.2) | — | | 13.0 | (0.10) | 13.0 | (0.10) | — | |
| (meth)acrylate | HEA | — | | 11.6 | (0.1) | — | | — | | 5.8 | (0.05) |
| Diisocyanate | IPDI | 44.5 | (0.4) | 33.3 | (0.3) | 33.3 | (0.3) | 44.5 | (0.4) | 22.3 | (0.2) |

| | | | | | | |
|---|---|---|---|---|---|---|
| | XDI | — | — | — | — | — |
| | DBTDL (g) | 0.138 | 0.112 | 0.121 | 0.198 | 0.139 |
| | MEHQ (g) | 0.014 | 0.011 | 0.012 | 0.020 | 0.014 |
| | THF (mL) | 70 | 55 | 60 | 100 | 70 |
| Parts by | Imine diol | 16.3 | 21.7 | 16.7 | 26.3 | 13.3 |
| equivalent | Polymer diol | 8.8 | 11.7 | 16.7 | 11.3 | 24.5 |
| | Hydroxyalkyl | 25.0 | 16.7 | 16.7 | 12.5 | 12.5 |
| | (meth)acrylate | | | | | |
| | Diisocyanate | 50.0 | 50.0 | 50.0 | 50.0 | 50.0 |
| GPC | Mw | 3,422 | 3,862 | 7,189 | 7,235 | 10,679 |
| analysis | PDI | 1.75 | 1.86 | 2.21 | 2.32 | 2.35 |

| Resin | | | | |
|---|---|---|---|---|
| | Comp. | Comp. | Comp. | Comp. |
| Resin 6 | Resin 1 | Resin 2 | Resin 3 | Resin 4 |

g (equivalent)

| | | | | | | | |
|---|---|---|---|---|---|---|---|
| (A)diol | Imine diol (Ia) | — | — | — | 26.6 | (0.10) | — |

| | | | | | | |
|---|---|---|---|---|---|---|
| Imine diol (Ib) | — | 2.61 | (0.01) | — | — | — |

| | Imine diol (II) | 6.37 | (0.10) | — | 47.79 | (0.27) | — | — | |
|---|---|---|---|---|---|---|---|---|---|
| | Imine diol (III) | — | | — | — | | — | 21.9 | (0.10) |
| (B) | Polyester diol | 114.0 | (0.114) | — | 30.0 | (0.03) | — | 100 | (0.10) |
| Polymer diol | PCL-diol | | | | | | | | |
| | (Mn 2000) (III) | | | | | | | | |

| Polycarbonate | — | 45.0 | (0.09) | — | — | | — |
|---|---|---|---|---|---|---|---|
| diol PHC-diol | | | | | | | |
| (Mn 1000) (IV) | | | | | | | |
| Polyether diol | | | | | 50.0 | (0.10) | — |
| PTMEG | | | | | | | |
| (Mn 2000) | | | | | | | |

| | | | | | | | |
|---|---|---|---|---|---|---|---|
| Hydroxyalkyl | HEMA | 6.5 | (0.05) | — | — | — | — |

| | | | | | | | | | | |
|---|---|---|---|---|---|---|---|---|---|---|
| (meth)acrylate | HEA | — | 11.6 | (0.1) | 11.6 | (0.1) | 11.6 | (0.1) | 11.6 | (0.1) |

| | | | | | | | | | |
|---|---|---|---|---|---|---|---|---|---|
| Diisocyanate | IPDI | — | — | 44.5 | (0.4) | 33.3 | (0.3) | 33.3 | (0.3) |

| | | | | | | | |
|---|---|---|---|---|---|---|---|
| XDI | 18.8 | (0.2) | 18.8 | (0.2) | — | — | — |

| | | | | | | |
|---|---|---|---|---|---|---|
| | DBTDL (g) | 0.146 | 0.082 | 0.134 | 0.110 | 0.167 |
| | MEHQ (g) | 0.015 | 0.008 | 0.013 | 0.011 | 0.0167 |
| | THF (mL) | 75 | 40 | 70 | 55 | 85 |
| Parts by | Imine diol | 9.0 | 2.5 | 33.8 | 16.7 | 16.7 |
| equivalent | Polymer diol | 28.5 | 22.5 | 3.8 | 16.7 | 16.7 |
| | Hydroxyalkyl | 12.5 | 25.0 | 12.5 | 16.7 | 16.7 |
| | (meth)acrylate | | | | | |
| | Diisocyanate | 50.0 | 50.0 | 50.0 | 50.0 | 50.0 |
| GPC | Mw | 11,350 | 5,830 | 4,032 | 6,953 | — |
| analysis | PDI | 2.45 | 1.95 | 2.05 | 2.16 | — |

### Polyurethane Diacrylate

80.0 g of PCL-diol, 4.65 g of HEA, 0.1 g of DBTDL, 0.01 g of MEHQ, and 100 mL of anhydrous THE were completely mixed and then heated to 55° C. 13.34 g of IPDI was slowly added to the mixture. After feeding IPDI, the mixture reacted at 55° C. for 15 hours to obtain polyurethane diacrylate, which was tracked by FT-IR to confirm whether the reaction was completed (confirm whether the —NCO absorption peak has disappeared). The polyurethane diacrylate was analyzed by GPC (with polystyrene as standard) to measure its Mw (15,400) and PDI (1.65).

### Resin Composition

30 parts by weight of the described resin (Resin 1, Resin 2, Resin 3, Resin 4, Resin 5, Resin 6, Comparative Resin 1, Comparative Resin 2, Comparative Resin 3), 30 parts by weight of the polyurethane diacrylate, 5 parts by weight of tris[2-(acryloyloxy)ethyl] isocyanurate (ARONIX M-315, commercially available from Toagosei Co. Ltd.), 25 parts by weight of bisphenol A glycerolate diacrylate (BPA-DA), 10 parts by weight of dimethylol tricyclodecane acrylate (TCD-DA), and 5 parts by weight of radical initiator dilauroyl peroxide were mixed to form resin compositions to visually confirm whether the resin compositions being uniformly mixed. Thin films having a thickness of 200±10 μm were prepared from the resin compositions, and then reacted at a temperature of 160° C. under a pressure of 1 kg/cm² for 10 seconds to measure the reaction exothermal amount before and after the reaction. The reaction rate of the film is calculated as the following formula, and whether the film was completely cured is judged by reaction rate>99.9%.

$$Reaction \text{} rate \text{} = [ 1 - ( exothermal amount before curing the film / exothermal amount after curing the film ) ] \times 100 \%$$

Alternatively, the resin composition was put into a vessel of 90 mm*12 mm*3 mm and then cured to form a bulk material that was analyzed by TGA to measure its thermal decomposition temperature (Td@5 wt % loss).

TABLE 2

| | | | | | | | Comp. | Comp. | Comp. |
|---|---|---|---|---|---|---|---|---|---|
| | Example 1 | Example 2 | Example 3 | Example 4 | Example 5 | Example 6 | Example 1 | Example 2 | Example 3 |
| Resin type | Resin 1 | Resin 2 | Resin 3 | Resin 4 | Resin 5 | Resin 6 | Comp. | Comp. | Comp. |
| | (30) | (30) | (30) | (30) | (30) | (30) | resin 1 | resin 2 | resin 3 |
| | | | | | | | (30) | (30) | (30) |
| Polyurethane | 30 | | | | | | | | |
| diacrylate | | | | | | | | | |
| M-315 | 5 | | | | | | | | |
| BPA-DA | 25 | | | | | | | | |
| TCD-DA | 10 | | | | | | | | |
| Initiator | 5 | | | | | | | | |
| Resin | ⊚ | ⊚ | ⊚ | ⊚ | ⊚ | ⊚ | ⊚ | X | X |
| Compatibility | | | | | | | | | |
| Reaction rate | 99.0% | 99.0% | 99.3% | 99.3% | 99.3% | 99.3% | 98.5% | — (No | — (No |
| | | | | | | | | reaction) | reaction) |
| Thermal | 300.3 | 301.1 | 308.5 | 305.5 | 312.5 | 313.2 | 311.3 | 302.5 | 258.6 |
| property | | | | | | | | | |
| Td (° C.) | | | | | | | | | |

⊚: Homogeneous single-phase after mixing the resin.
X: Immiscible two-phase after mixing the resin

In addition, the cured bulk material (90 mm*12 mm*3 mm) was cut to a small bulk material (10 mm*12 mm*3 mm) having a weight of 0.37±0.01 g. The cut bulk material was dipped in 3 g of an acetic acid solution (pH1=3) at 55° C. to degrade the bulk material. The dipped bulk material was taken out every hour to measure its weight to calculate the weight loss of the bulk material, as shown in Table 3.

TABLE 3

| | | | | | | | Comp. | Comp. | Comp. |
|---|---|---|---|---|---|---|---|---|---|
| | Example 1 | Example 2 | Example 3 | Example 4 | Example 5 | Example 6 | Example 1 | Example 2 | Example 3 |
| | Degradation test in acetic acid at 55° C. | | | | | | | | |
| Time: 1 hr | ◯ | ◯ | Δ | ◯ | Δ | X | X | — | — |
| Time: 2 hr | ⊚ | ⊚ | ◯ | ⊚ | ◯ | Δ | X | — | — |
| Time: 3 hr | ⊚ | ⊚ | ⊚ | ⊚ | ⊚ | ◯ | X | — | — |
| Time: 4 hr | ⊚ | ⊚ | ⊚ | ⊚ | ⊚ | ⊚ | X | — | — |

X: bulk material weight loss was 0%~25%;
Δ: bulk material weight loss was 25%~50%;
◯: bulk material weight loss was 50%~75%;
⊚: bulk material weight loss was 75%~100%.

The cut bulk material was dipped in 2 g of an ethylene diamine solution (pH=12) at 55° C. to degrade the bulk material. The dipped bulk material was taken out every hour to measure its weight to calculate the weight loss of the bulk material, as shown in Table 4.

TABLE 4

| | | | | | | | Comp. | Comp. | Comp. |
|---|---|---|---|---|---|---|---|---|---|
| | Example | Example | Example | Example | Example | Example | Example | Example | Example |
| | 1 | 2 | 3 | 4 | 5 | 6 | 1 | 2 | 3 |
| | Degradation test in ethylenediamine alkaline solution at 55° C. | | | | | | | | |
| Time: 1 hr | Δ | Δ | Δ | Δ | Δ | X | X | — | — |
| Time: 2 hr | Δ | Δ | Δ | Δ | Δ | Δ | X | — | — |
| Time: 3 hr | ◯ | ◯ | ◯ | ◯ | ◯ | ◯ | X | — | — |
| Time: 4 hr | ⊚ | ⊚ | ◯ | ⊚ | ◯ | ◯ | X | — | — |
| Time: 5 hr | ⊚ | ⊚ | ⊚ | ⊚ | ⊚ | ⊚ | X | — | — |

X: bulk material weight loss was 0%~25%;
Δ: bulk material weight loss was 25%~50%;
◯: bulk material weight loss was 50%~75%;
⊚: bulk material weight loss was 75%~100%.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polyurethane acrylate resin, being formed by reacting
6 to 30 parts by equivalent of (A) imine diol;
6 to 30 parts by equivalent of (B) polyester diol, polycarbonate diol, or a combination thereof;
10 to 30 parts by equivalent of (C) hydroxyalkyl acrylate, hydroxyalkyl methacrylate, or a combination thereof; and
50 parts by equivalent of (D) diisocyanate,
wherein (A) imine diol has a chemical structure of 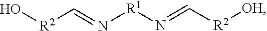
wherein R¹ is 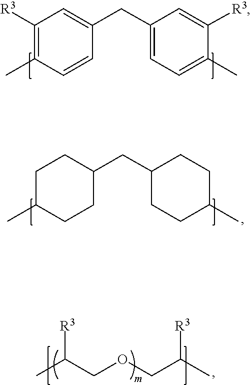
linear —(CₙH₂ₙ)— or branched —(CₙH₂ₙ)—, wherein m=2 to 40, n=2 to 16, and each of R³ is independently C₁₋₆ alkyl group; and
each of R² is independently substituted or unsubstituted C₂₋₂₄ alkylene group or C₃₋₂₄ cycloalkylene group, or substituted or unsubstituted C₆₋₂₄ monocyclic or bicyclic arylene group.

2. The polyurethane acrylate resin as claimed in claim 1, wherein each of R² is independently,

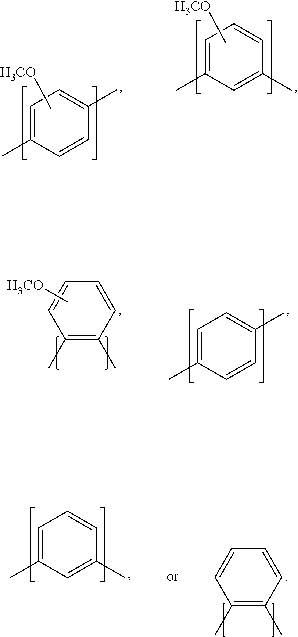

3. The polyurethane acrylate resin as claimed in claim 1, wherein the polyester diol comprises polycaprolactone diol, poly(ethylene glycol adipate) diol, poly(ethylene terephthalate) diol, polypentadecanolactone diol, polylaurolactone diol, or a combination thereof.

4. The polyurethane acrylate resin as claimed in claim 1, wherein the polycarbonate diol comprises poly(hexamethylene carbonate) diol, poly(pentamethylene carbonate) diol, poly(tetramethylene carbonate) diol, poly(trimethylene carbonate) diol, poly(dimethylene carbonate) diol, or a combination thereof.

5. The polyurethane acrylate resin as claimed in claim 1, wherein the hydroxyalkyl acrylate comprises 2-hydroxyethyl acrylate, 2-hydroxypropyl acrylate, 4-hydroxybutyl acrylate, methyl 2-(1-hydroxyethyl)acrylate, or a combination thereof, and the hydroxyalkyl methacrylate comprises 2-hydroxyethyl methacrylate, 2-hydroxypropyl methacrylate, 4-hydroxybutyl methacrylate, methyl 2-(1-hydroxyethyl)methacrylate, or a combination thereof.

6. The polyurethane acrylate resin as claimed in claim 1, wherein the diisocyanate comprises isophorone diisocyanate, m-xylylene diisocyanate, toluene-2,4-diisocyanate, diphenylmethane diisocyanate, dicyclohexylmethane diisocyanate, lysine diisocyanate, or a combination thereof.

7. The polyurethane acrylate resin as claimed in claim 1, wherein the total parts by equivalent of (A) imine diol, (B) polyester diol, polycarbonate diol, or a combination thereof, and (C) hydroxyalkyl acrylate, hydroxyalkyl methacrylate, or a combination thereof is equal to the parts by equivalent of (D) diisocyanate.

8. The polyurethane acrylate resin as claimed in claim 1, wherein the polyurethane acrylate resin has a weight average molecular weight of 500 to 20000.

9. A resin composition, comprising:
100 parts by weight of the polyurethane acrylate resin as claimed in claim 1;
50 to 200 parts by weight of a multi-acrylate compound; and
5 to 35 parts by weight of a radical initiator.

10. The resin composition as claimed in claim 9, wherein the multi-acrylate compound comprises tris[2-(acryloyloxy)ethyl] isocyanurate, bisphenol A glycerolate dimethacrylate, tricyclodecane dimethanol diacrylate, bis(2-acryloyloxyethyl) isocyanurate, terephthalic acid diallyl ester, bisphenol A ethoxylate diacrylate, polycaprolactone diacrylate, 1,3-butanediol diacrylate, 1,4-butanediol diacrylate, 1,6-hexanediol diacrylate, ethylene glycol diacrylate, di(ethylene glycol) diacrylate, poly(ethylene glycol) diacrylate, poly(propylene glycol) diacrylate, neopentyl glycol diacrylate, tetra(ethylene glycol) diacrylate, trimethylaniline diacrylate, tri(ethylene glycol) diacrylate, 9-(acryloyloxy)nonyl acrylate, ethoxylated trimethylolpropane diacrylate, tri(propylene glycol) diacrylate, or a combination thereof.
